(19) United States
(12) Patent Application Publication
(10) Pub. No.: US 2002/0158035 A1
(43) Pub. Date: Oct. 31, 2002

(54) System for lifting and moving an object

(76) Inventor: Francois Delaney, L'Assomption (CA)

Correspondence Address: BROUILLETTE KOSIE, 25th Floor, 1100 Rene-Levesque Boulevard West, Montreal, QC, H3B 5C9, CA

(21) Appl. No.: 10/073,286

(22) Filed: Feb. 13, 2002

Related U.S. Application Data
(60) Provisional application No. 60/268,300, filed on Feb. 13, 2001.

(30) Foreign Application Priority Data
Feb. 13, 2001 (CA) 2,335,897

(51) Int. Cl. B66C 23/76

(52) U.S. Cl. 212/250

(57) ABSTRACT

A system for lifting and moving an object comprising a vertical post, having a lifting arm pivotably mounted thereon. Said vertical post comprising a piston connected to a carriage slidably mounted on said lifting arm, such that operation of said piston can lower and raise said carriage.

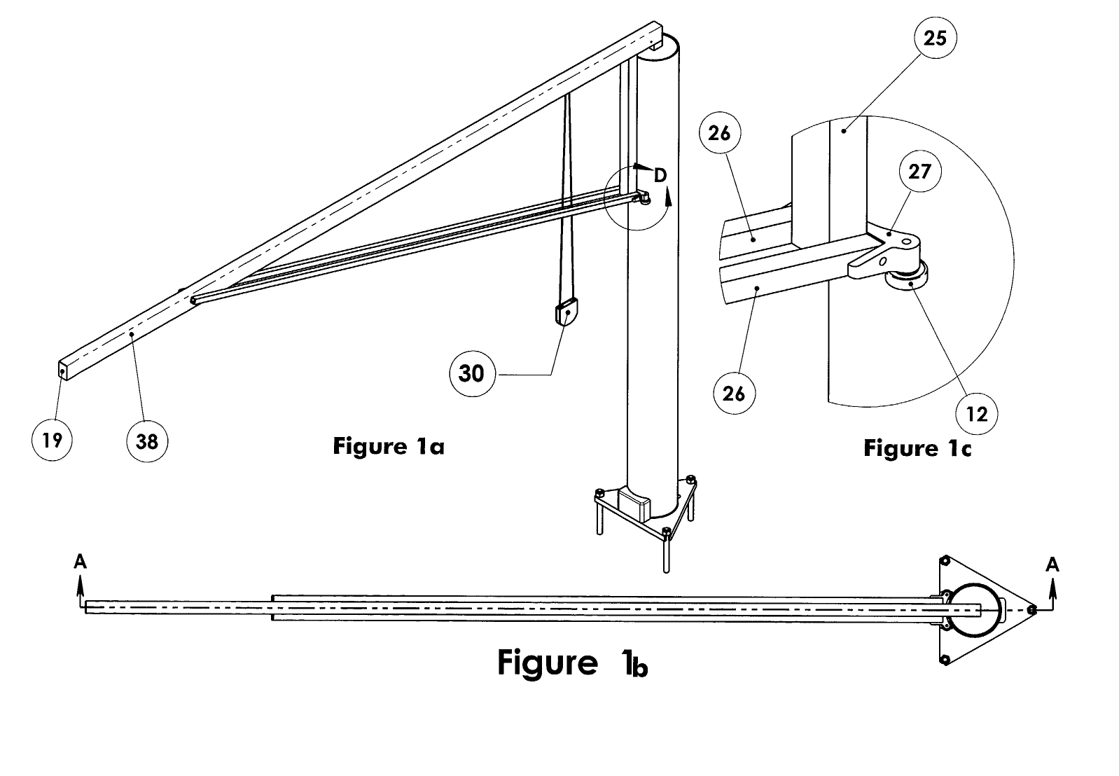

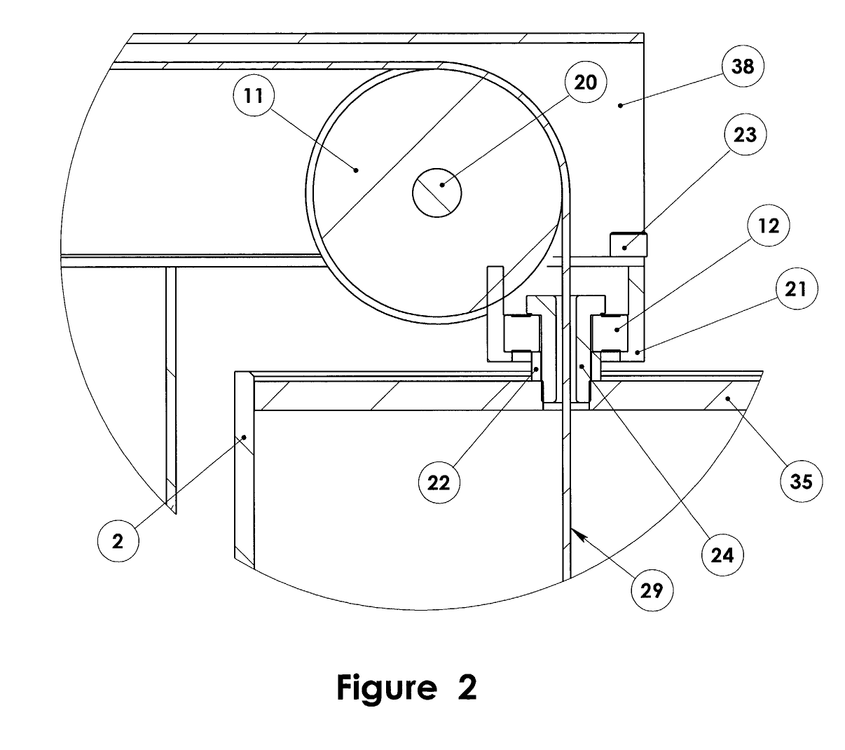

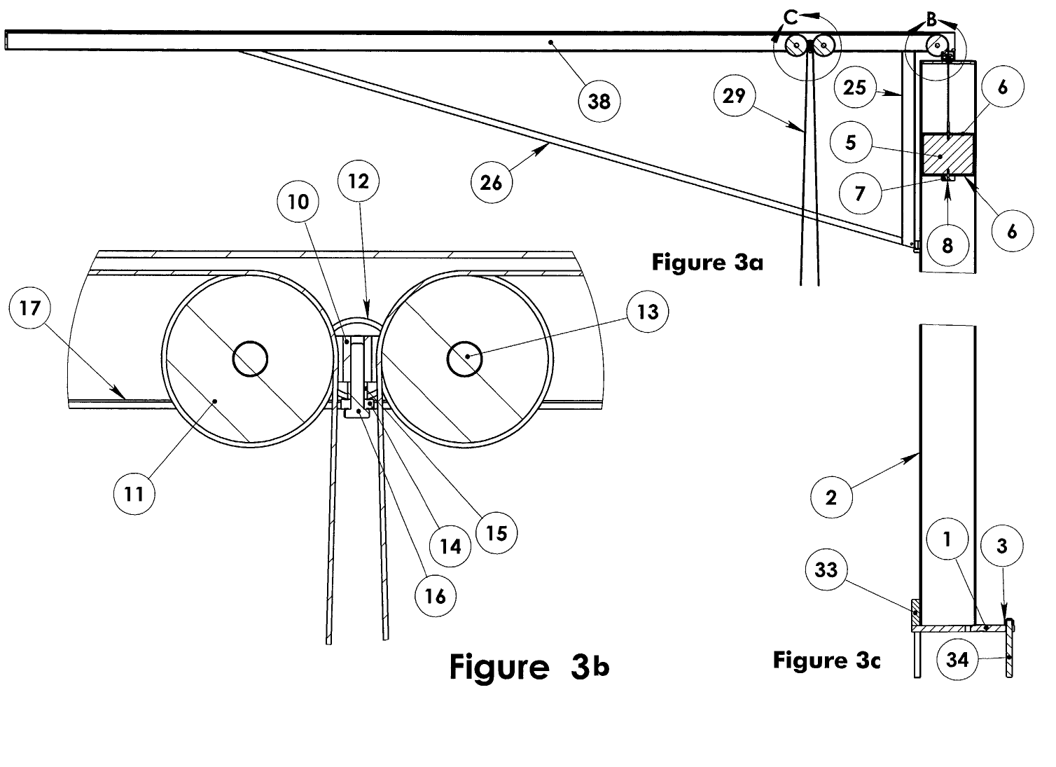

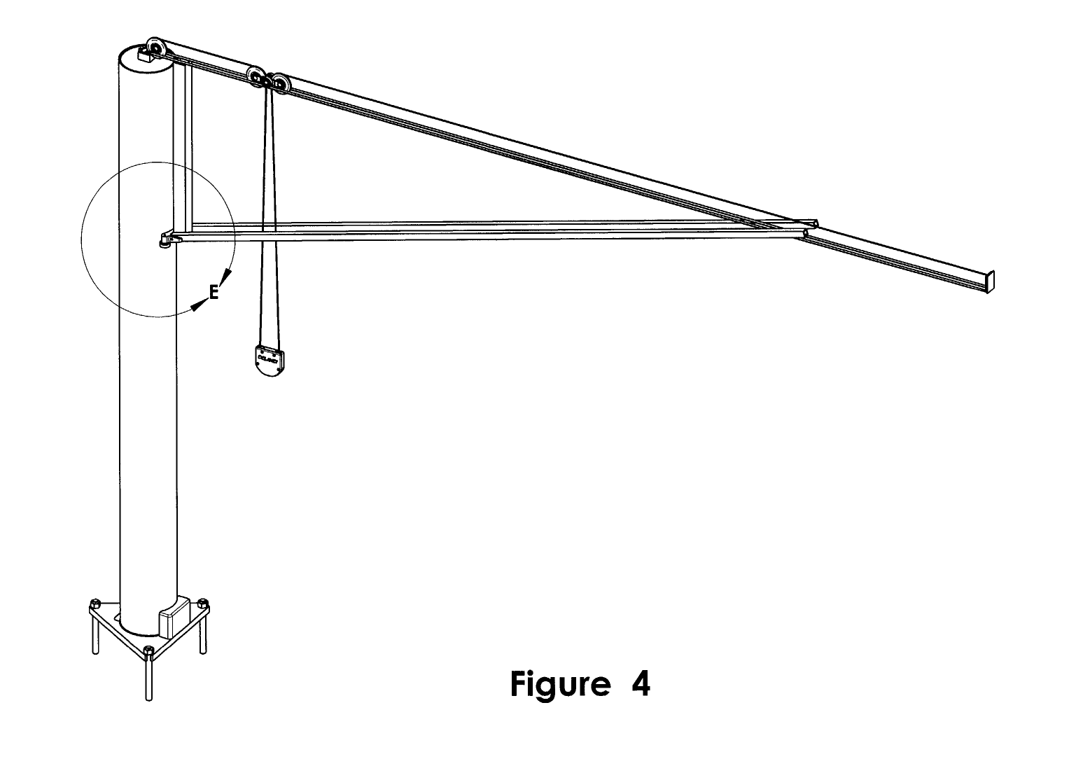

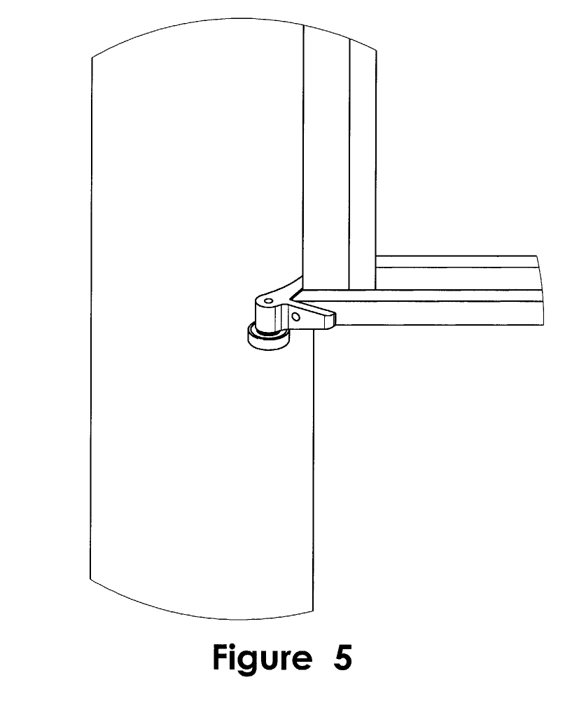

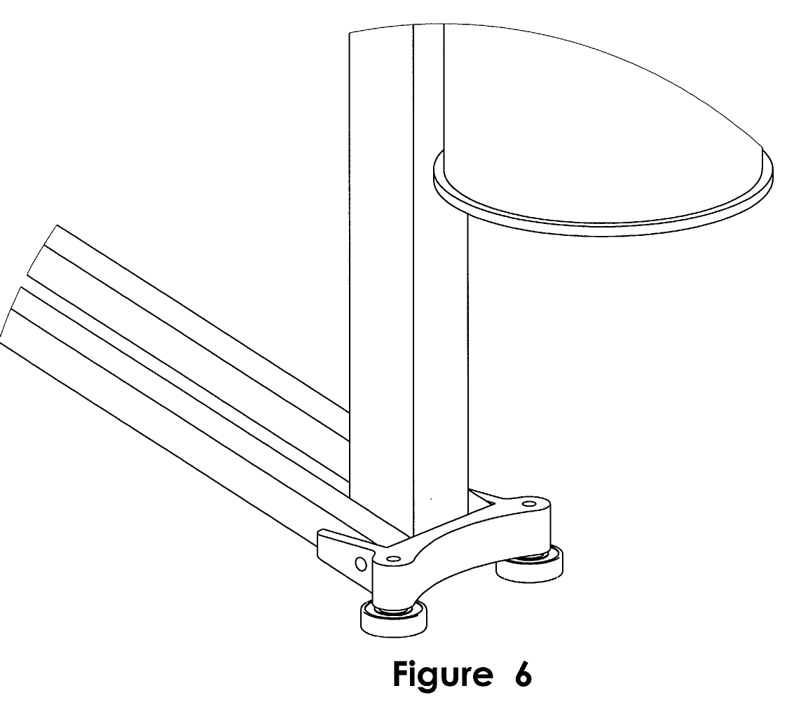

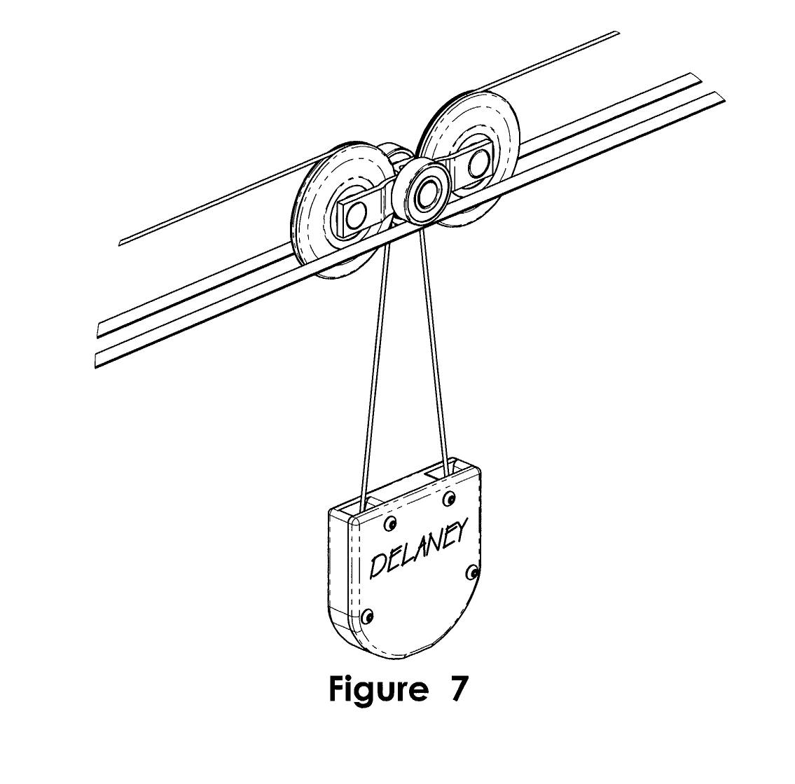

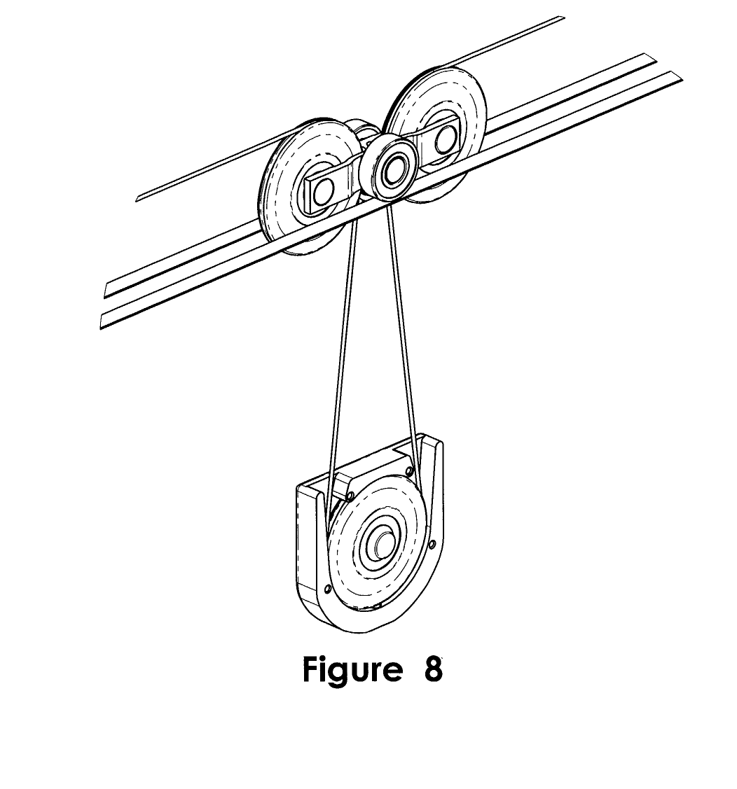

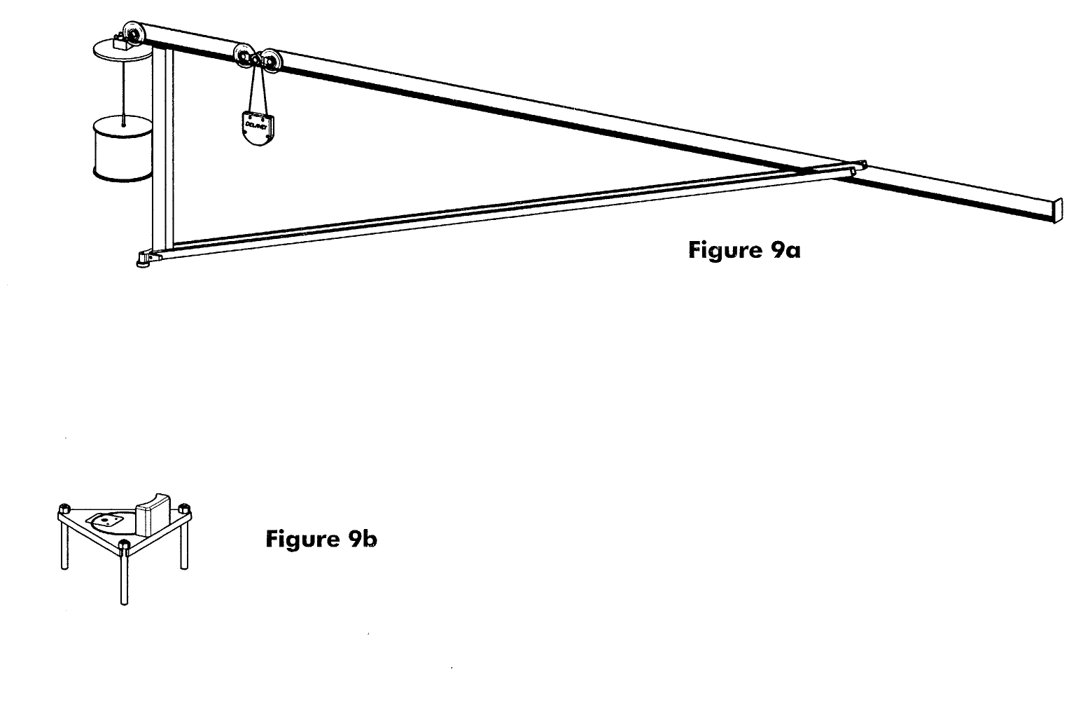

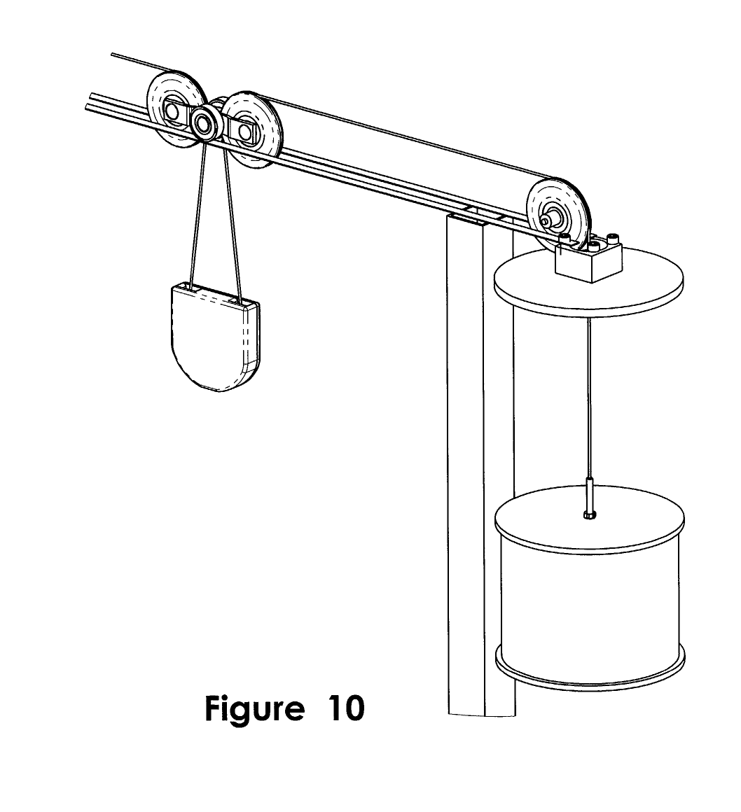

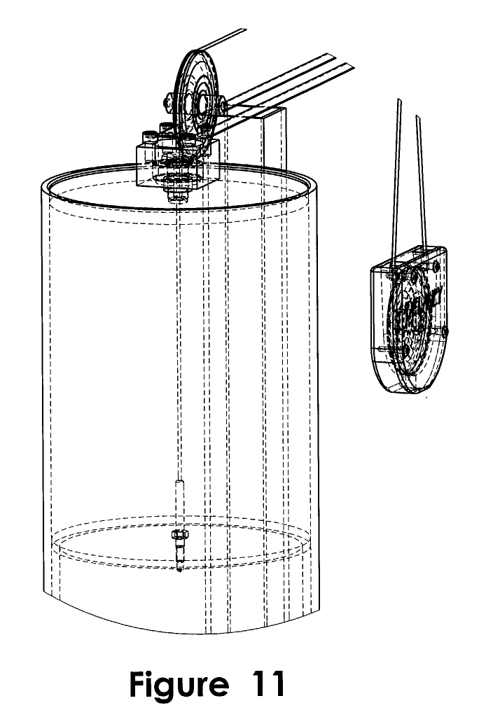

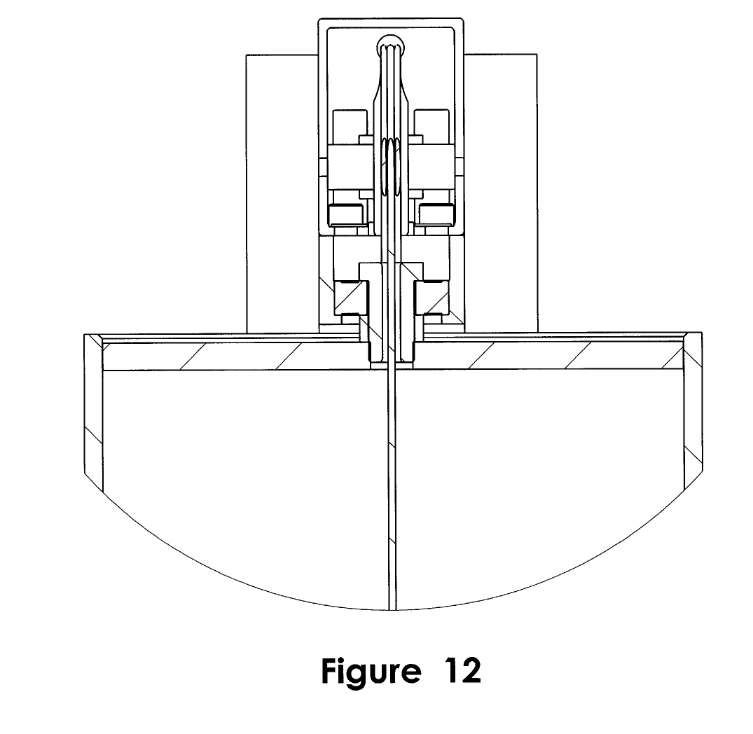

System to lift and move an object from one location to another, composed of:

a partially hollow vertical post, equipped at its base with a rotating system using the post as its vertical axis and ensuring its solidity with the help of a support which could be the soil itself;

a lateral arm firmly held to the vertical post by a pivot and equipped with a rail on which a carriage moves.

one or many supporting arms firmly held to the vertical post used as a support to the lateral arm; and

a holding system for an object held by a cable to the lateral arm's carriage.

Characterized by means of:

a lateral arm firmly held to the vertical post in ways that allow movement in any pattern passing by the axis of the post;

the verdical post equipped inside with a piston moving up and down, preferably under pressure created by a fluid, either liquid, gaseous or granular and preferably within such element as air, inert gases, synthetic or natural oil, mercury, water or sand;

the aforementioned piston being held by a cable to the carriage moving in or on the lateral arm's rail and with the object's holding system; and

the carriage, preferably equipped with a pulley system, which would allow its movement along the lateral arm and forcing the holding system to remain at the same distance from the carriage no matter its position on the arm.

The equipment consist of a 12 foot rail (9) fastened to the top of an 8 to 12 foot high, 8 inch diameter post (2)

The rail fastening is on a rotating joint (12-21-22-23-24) whichs allows continuous movement at 360 degrees.

A hole in the rotating joint allows the free movement of a cable (29) while the counterweight rises or lowers.

The rail (9) is supported by two 1-inch square braces (26) bolted (28) to a rolling block (27).

The rolling block (27) can move up and down on the outside of the post (2) with the help of two bearings (12).

A small carriage (10-11-12-13-14-15-16) installed inside the rail (9) allows the load to move freely along the rail.

At the end of the rail (9), is capped (19) to close the opening and hold the end of the cable (29) in place.

The bottom of the post (2) is welded to a triangular base (1) anchored (3-4) to the floor at each angle and filled with epoxy.

Two plastic rings (6) installed on top and bottom of the counterweight (5) prevent friction between metal parts. They are adjusted to let air or other gazes leak at a preset volume, depending on the requirement.

A valve installed at the bottom of the post allows the control of air intake used to lift the counterweight.

### DESCRIPTION OF THE EQUIPMENT

A piece of rubber (7) bolted (8) to the bottom of the counterweight elimates impacts when lowering.

Two black, high-density steel bands (17) inside the rail (9) smoothen the movement of the carriage (10-11-12-13-14-15-16).

A ⅝-inch bearing (15) insures aligning action of the carriage in the rail (9) opening

The attachment block (30) prevent cables (29) from falling off the pulley (11) by keeping them under tension.

Equipment Mechanical Function

This apparatus has three distinct functions:

a) Cancel the weight of an object to be lifted by a counterweight;

b) Allow the operator to lift and lower an object with ease; and

c) Move an object with a radius between two to 12 feet at 360 degrees.

Equipment Operating Procedures

This equipment is a lifting arm allowing easy handling of any solid object which can be held by a suction disc, a magnet, a hook or any other holding system.

The operator can handle the object within a diameter of 24 feet and controls the lifting and lowering by a remote control either wireless or connected.

The stand on which the remote control is installed is also used as a handle for the operator at the base of the holding system.

The holding system can be of any applicable shape.

Using a melamine-coated sheet as an example, the operator inserts air under the counterweight. As a result, the holding system (in this case the suction disk) lowers on top of the sheet. Once the sheet is appropriately held, he releases the air and the counterweight lowers thus lifting the sheet. The operator can then move the sheet where required and reinsert air to lower it. Finally, he releases the sheet and is ready for another maneuver.

This equipment is designed to handle small charges varying from 50 to 150 lbs.

Main Claim

System to lift and move an object from one location to another, composed of:

A partially hollow vertical post, equipped at its base with a rotating system using the post as its vertical axis and ensuing its solidity with the help of a support which could be the soil itself;

A lateral arm firmly held to the vertical post by a pivot and equipped with a rail on which a carriage moves.

One or many supporting arms firmly held to the vertical post used as a support to the lateral arm; and

A holding system for an object held by a cable to the lateral arm's carriage.

Characterized by mean of:

A lateral arm firmly held to the vertical post in ways that allow movement in any pattern passing by the axis of the post;

The vertical post equipped inside with a piston moving up and down, preferably under pressure created by a fluid, either liquid, gaseous or granular and preferably within such element as air, inert gases, synthetic or natural oil, mercury, water or sand;

The aforementioned piston being firmly held by a cable to the carriage moving in or on the lateral arm and forcing the holding system to remain at the same distance from the carriage no matter its position on the arm.

The principal aspect to be claimed with this invention is “the operation of the counterweight”:

1. Its rising movement is made possible with low air pressure at four pounds per square inches (4 PSI).

2. The sealing principle of the counterweight (piston) is to use air friction when it is moved through a small crack. This principle allows the creation of air pressure below the piston using very little air.

3. Another advantage with this principle is the fact that the small air leak created causes the piston to stay perfectly centered in the tube and eliminates wearing effect.

4. Along with insuring guiding and sealing, the use of this leaking system eliminates the need to pressurize the top of the piston or the use of air exhaust valve. This system requires only the reduction or closing of the air intake to allow the counterweight to lower simply by gravity thus rising the object.

5. It is impossible to abuse or break this equipment due to the fact that it can only lift 99% of the counterweight. Friction of mechanical elements is the reason for the 1% loss.

6. Using the supporting post as the compression chamber allows 360 degree continuous movement.

7. The closesness of the pulleys supporting the carriage system produce a breaking effect in the event the operator would try to rise too high the counterweight.

8. The counterweight can be of variable weight:
It is a container equipped with a trap on the bottom that allows rapid emptying.
This container is open on top. A tank installed on top of the equipment can be filled with granular material or liquid using quiet moments. A trap on its bottom is used to fill the counterweight container as required.
The method of bringing granular material or liquid can be achieved by using a ¼ HP small conveyor system with jars in a continuous movement.
Management of the counterweight can be made possible by using liquids (water, oil, mercury) or granular material (sand, steel balls, polymeric balls).
If mercury is chosen, everything must be done in closed circuit in order to avoid possible environment contamination. It must be noted that mercury has the advantage of being very compact althought extremely expensive.
